(19) United States
(12) Patent Application Publication
(10) Pub. No.: US 2014/0172962 A1
(43) Pub. Date: Jun. 19, 2014

(54) Method and system for prompting friend feed in SNS network, client and server

(71) Applicant: TENCENT TECHNOLOGY (SHENZHEN) COMPANY LIMITED, Shenzhen (CN)

(72) Inventors: Junxiu Zhu, Shenzhen (CN); Xue Zhang, Shenzhen (CN); Gengwu Yan, Shenzhen (CN)

(21) Appl. No.: 14/185,280

(22) Filed: Feb. 20, 2014

Related U.S. Application Data
(63) Continuation of application No. PCT/CN2012/079052, filed on Jul. 23, 2012.

(30) Foreign Application Priority Data
Aug. 26, 2011 (CN) 2011102485925

(51) Int. Cl. H04L 29/08

(52) U.S. Cl. CPC H04L 67/10
USPC 709/203

(57) ABSTRACT

The disclosure provides a method for prompting a friend feed in a Social Network Service (SNS) network. The method includes: acquiring user information of a user by an SNS network client, when the user enters an application program store; acquiring, by the SNS network client, a friend feed of the user from an SNS network server according to the user information, wherein the friend feed includes at least one piece of Application Program (App) feed information; and prompting the friend feed by the SNS network client. The disclosure further provides a client, a server, and a system for prompting a friend feed in an SNS network. The disclosure improves the stickiness and activeness of the user and takes full advantage of the SNS.

### CROSS REFERENCE TO RELATED APPLICATIONS

This is a continuation application of International Patent Application No.: PCT/CN2012/079052, filed on Jul. 23, 2012, which claims priority to Chinese Patent Application No.:201110248592.5, filed on Aug. 26, 2011, the disclosure of which is incorporated by reference herein in its entirety.

### TECHNICAL FIELD

The disclosure relates to the field of network technology, and in particular to a method and a system for prompting a friend feed in a Social Network Service (SNS) network, a client and a server.

### BACKGROUND

SNS network is established based on six degrees of separation, with the purpose of helping people establish Internet application services of social network. Through the use of SNS network, personal data processing, personal social relationship management, credible business information sharing, safely sharing one's own information and knowledge to trusted people, and expanding one's own social network using trusted relationship can be realized, so that more valuable communication and collaboration can be achieved.

In the SNS network, Application Program (App), which is provided by a third party, is an important part. A user can enter an App through an SNS network platform to use the service provided by the App. In the SNS network, users often expect to know friend feeds, including the use of App by friends. At present, the SNS network prompts friend feeds through a Feed mechanism (feed refers to newly events, which is a short message on friend status in the SNS network). The feed mechanism mainly includes: an SNS network server records the App installation condition of a friend of a user to generate a friend feed; when the user accesses the SNS network, the SNS network server pushes the friend feed to an SNS network client adopting the Feed, and the SNS network client displays the friend feed to the user, for example, friend A used an App. In the above solution, the friend feed is generated when the friend installs the App, however, the friend feed is prompted when the user accesses the SNS network, that is, the friend feed is not prompted instantly; thus, users cannot learn the latest feed of friends, the stickiness and activeness of users cannot be improved, and the function of the SNS network cannot be played fully. In addition, when each friend installs an App each time, one piece of friend feed is generated to be pushed to the user, and each piece of friend feed contains one Feed only. Due to the difference in installation time, the friend feed needs to be prompted to the user separately, thus, trouble is caused to users to some extent.

### SUMMARY

Embodiments of the disclosure are to provide a method and a system for prompting a friend feed in an SNS network, a client and a server, so as to prompt the friend feed to a user when the user enters an application program store through the SNS network, wherein the friend feed reflects the App use condition of several friends of the user, thereby improving the stickiness and activeness of the user and taking full advantage of the SNS.

An embodiment of the disclosure provides a method for prompting a friend feed in an SNS network, which includes:
acquiring user information of a user by an SNS network client, when the user enters an application program store;
acquiring a friend feed of the user from an SNS network server according to the user information by the SNS network client, wherein the friend feed may include at least one piece of App feed information; and
prompting the friend feed by the SNS network client.

Correspondingly, the embodiment of the disclosure further provides a client, which is applied to an SNS network and includes:
an information acquisition module configured to acquire user information of a user when the user enters an application program store;
a feed acquisition module configured to acquire a friend feed of the user from an SNS network server according to the user information acquired by the information acquisition module, wherein the friend feed may include at least one piece of App feed information; and
a prompt module configured to prompt the friend feed acquired by the feed acquisition module.

Correspondingly, the embodiment of the disclosure further provides a server, which is applied to an SNS network and includes:
an information receiving module configured to receive user information sent by an SNS network client;
a feed generation module configured to generate a friend feed of the user according to the user information received by the information receiving module, wherein the friend feed may include at least one piece of App feed information; and
a push module configured to push the friend feed generated by the feed generation module to the SNS network client.

Correspondingly, the embodiment of the disclosure also provides a system for prompting a friend feed in an SNS network, which includes a server and a client.

The client is configured to acquire user information of a user when the user enters an application program store, to acquire a friend feed of the user from the server according to the user information and to prompt the friend feed, wherein the friend feed may include at least one piece of App feed information; and
the server is configured to receive the user information from the client, to generate the friend feed of the user according to the user information, and to push the friend feed to the client.

The embodiment of the disclosure has advantages as follows:

According to the embodiment of the disclosure, when a user enters an application program store, the SNS network client acquires a friend feed of the user and prompts the friend feed to the user. Since the friend feed is generated and pushed instantly, the user can learn the latest feed of friends. Thus, the stickiness and activeness of the user is improved and the function of the SNS is played fully. Moreover, the friend feed includes at least one piece of App feed information, that is to say, the friend feed reflects the App use condition of several friends, thereby avoiding the trouble caused by separate prompt and improving the user experience.

### BRIEF DESCRIPTION OF THE DRAWINGS

FIG. 1 shows a structure diagram of a system for prompting a friend feed in an SNS network provided by the embodiment of the disclosure;

FIG. 2 shows a structure diagram of a client provided by the embodiment of the disclosure;

FIG. 3 shows a diagram for showing a friend feed provided by the embodiment of the disclosure;

FIG. 4 shows a structure diagram of the embodiment of a feed acquisition module shown in FIG. 2;

FIG. 5 shows a structure diagram of a server provided by the embodiment of the disclosure;

FIG. 6 shows a structure diagram of the embodiment of a feed generation module shown in FIG. 5;

FIG. 7 shows a structure diagram of the embodiment of an aggregation unit shown in FIG. 6;

FIG. 8 shows a flowchart of one embodiment of a method for prompting a friend feed in an SNS network provided by the embodiment of the disclosure;

FIG. 9 shows a flowchart of another embodiment of the method for prompting a friend feed in an SNS network provided by the embodiment of the disclosure; and

FIG. 10 shows a specific flowchart of Step 205 shown in FIG. 9.

### DETAILED DESCRIPTION

The technical solution provided in the embodiment of the disclosure is described below clearly and completely in conjunction with the accompanying drawings mentioned in the embodiment of the disclosure. Obviously, the described embodiment is part embodiments of the disclosure only, not all the embodiments. Based on the embodiment of the disclosure, all other embodiments obtained by those skilled in the art without exercising inventive skill are deemed to be included in the scope of protection of the disclosure.

In the solution provided by the embodiment of the disclosure, when a user enters an App Store, an SNS network client acquires a friend feed of the user and prompts the friend feed to the user. Since the friend feed is generated and pushed instantly, the user can learn the latest feed of friends. Thus, the stickiness and activeness of the user is improved and the function of the SNS is fully played. Moreover, the friend feed includes at least one piece of App feed information, that is to say, the pushed friend feed reflects the App use condition of several friends, thereby avoiding the trouble caused by separate prompt and improving the user experience.

It should be noted that the user referred in the embodiment of the disclosure is any user registered in the SNS network. When other users other than this user enter the App Store, this user can act as a friend of other users, and the SNS network can push the App feed of this user to other users as a friend feed.

Hereinafter, a system for prompting a friend feed in an SNS network provided by the embodiment of the disclosure is described in detail in conjunction with FIG. 1.

FIG. 1 shows a structure diagram of the system for prompting a friend feed in an SNS network provided by the embodiment of the disclosure. The system includes a client 10 and a server 20.

The client 10 is configured to acquire user information of a user when the user enters an application program store, to acquire a friend feed of the user from the server 20 according to the user information, and to prompt the friend feed. The friend feed includes at least one piece of App feed information.

The server 20 is configured to receive the user information from the client 10, to generate the friend feed of the user according to the user information, and to push the friend feed to the client 10.

The server 20 includes a distributed memory system (T Memory). The T Memory is able to store the following information: the personal information of all users registered in the SNS network, for example, user identification (account and/or nickname), user homepage link, user's major, age, native place and the like; the social relationship of the users in the SNS network, for example, friend relationship, stranger relationship, blacklisted contact relationship and the like; and the history data of each user in the SNS network, for example, history data of App usage, history data of SNS network login and the like. The server 20 can update all the information stored in the T Memory at regular time.

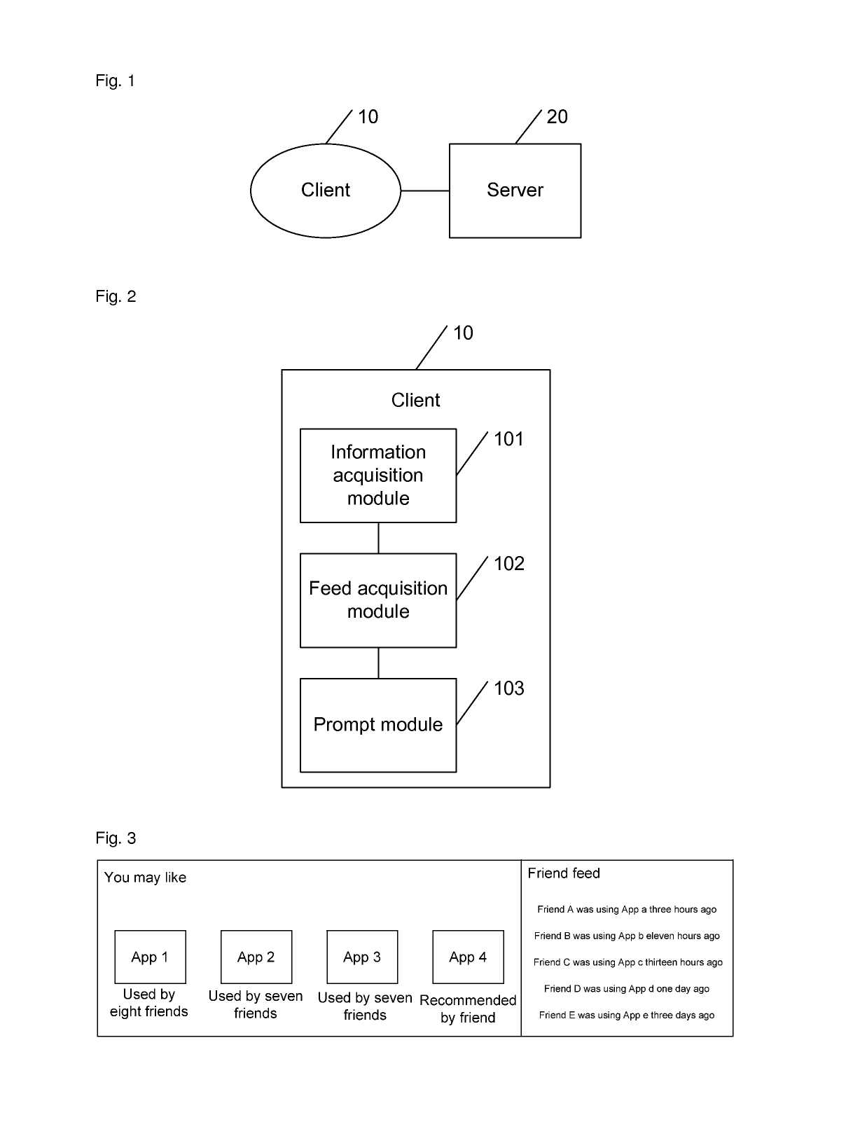

Hereinafter, the client provided by the embodiment of the disclosure is described in detail in conjunction with FIG. 2 to FIG. 4. This client can be the client 10 included in the system for prompting a friend feed in an SNS network shown in FIG. 1.

FIG. 2 shows a structure diagram of the client provided by the embodiment of the disclosure. The client 10 includes an information acquisition module 101, a feed acquisition module 102 and a prompt module 103.

The information acquisition module 101 is configured to acquire user information of a user when the user enters an application program store.

The feed acquisition module 102 is configured to acquire a friend feed of the user from an SNS network server according to the user information acquired by the information acquisition module 101. The friend feed includes at least one piece of App feed information.

The App feed information may include: information of an App, information of a friend using the App and the usage time, in which the information of the friend refers to the friend's personal information, which includes: friend identification, friend homepage link, friend's major, age, native place and the like. The information of the App may include: App identification (App ID and/or App name) and details page link of the App. The usage time is a difference value between the time when the user enters the application program store and the time when the friend enters the App.

The prompt module 103 is configured to prompt the friend feed acquired by the feed acquisition module 102.

The prompt module 103 may be a display module of the client 10 to show the friend feed to the user, so that the user can learn the App use condition of friends intuitively. FIG. 3 shows a diagram for showing the friend feed provided by the embodiment of the disclosure. In the example shown in FIG. 3, the friend feed prompted by the prompt module 103 totally includes 5 pieces of App feed information. It should be noted that the number of pieces of App feed information contained in the friend feed prompted each time can be preset according to actual needs, for example, the number can be preset according to the size of the display page of the client or the size of the area for displaying the friend feed. As shown in FIG. 3, the prompt module 103 can display the friend feed at the side of App recommendation in the SNS network, so that the SNS network can attract the user to use the recommended App or other Apps in the App store according to the friend feed, thereby improving the stickiness and activeness of the user and taking full advantage of the SNS. It should be understood that the prompt module 103 can prompt the friend feed through other manners such as voice and multimedia message. The analysis in these manners is similar to the above, thus giving no further description.

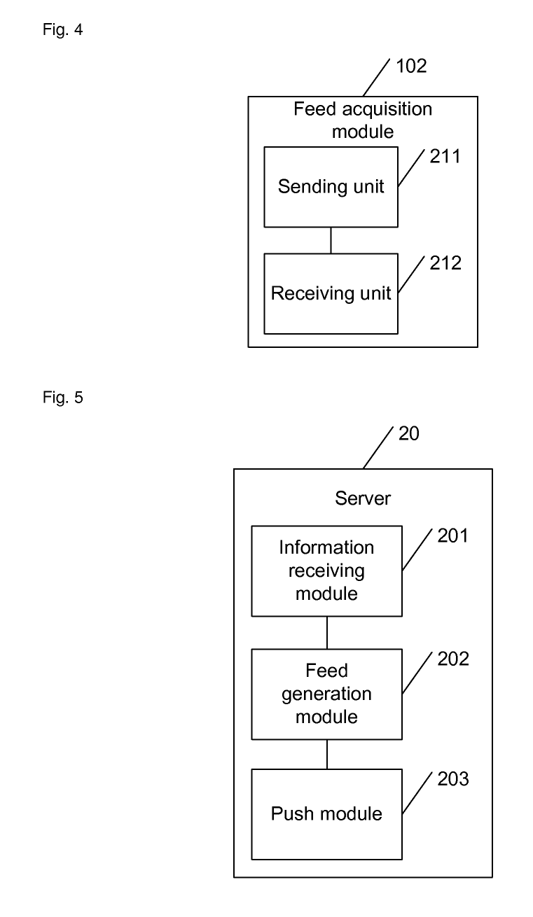

FIG. 4 shows a structure diagram of the embodiment of the feed acquisition module shown in FIG. 2. The feed acquisition module 102 includes a sending unit 211 and a receiving unit 212.

The sending unit 211 is configured to send the user information acquired by the information acquisition module 101 to the SNS network server.

The receiving unit 212 is configured to receive the friend feed of the user pushed by the SNS network server.

The sending unit 211 and the receiving unit 212 can be combined into one unit, which serves as a transceiving unit of the client 10 to implement the interaction between the client 10 and an external device (for example, SNS network server).

Hereinafter, the client 10 provided by the embodiment of the disclosure is described in detail through a specific example.

For example: user A has friends B and C; the personal information of A, B and C is stored in the client 10; the friend relationship between A and B, between A and C is stored in the client 10; the information of the App used by A, B and C in the SNS network is stored in the client 10. B entered “App 1” at 23:00, Jul. 31, 2011; C entered “App 2” at 12:00, Jul. 31, 2011 and entered “App 1” at 16:00, Jul. 31, 2011, respectively.

A enters App Store through the client in the SNS network at 9:00, Aug. 1, 2011. The information acquisition module 101 acquires the user information of A. The user information may include: identification and homepage link of A. The sending unit 211 of the feed acquisition module 102 sends the user information of A to the SNS network server, and waits the SNS network server to process to obtain a friend feed according to the user information of A. When the SNS network server returns the friend feed, the receiving unit 212 of the feed acquisition module 102 receives the friend feed and forwards the friend feed to the prompt module 103 to prompt. The prompted friend feed may include two pieces of App feed information, which are: (1) B and C were using App 1 ten hours ago; (2) C was using App 2 twenty-one hours ago. It should be understood that the App feed information included in the friend feed may be of other conditions due to different rules on which the SNS network server are based, for example, only one piece of App feed information is included, or three pieces of App feed information are included.

In the first App feed information, “App 1” can be the name of an App, and the name can be edited as a details page link of the App. Once the user clicks the name, the user can link to the details page of the App. “B” and “C” can be the nickname of B and C respectively, and the nickname can be edited as a personal page hyperlink. Once the user clicks the nickname of B, the user can link to the personal page of B, and once the user clicks the nickname of C, the user can link to the personal page of C. “10 hours” refers to the usage time, and this time is equal to a difference value between the time when A enters the App Store and the time when B enters this App. The analysis of the second App feed information can be referred to the first App feed information, thus giving no further description. The order of the App feed information in the displayed friend feed is from the first App feed information to the second one, reflecting that the App feed information in the friend feed is arranged according to an order from the minimum usage time to the maximum usage time, so that the user can learn the latest App use condition of friends at the top of the friend feed.

Hereinafter, the server provided by the embodiment of the disclosure is described in detail in conjunction with FIG. 5 to FIG. 7. This server can be the server 20 included in the system for prompting a friend feed in an SNS network shown in FIG. 1.

FIG. 5 shows a structure diagram of the server provided by the embodiment of the disclosure. The server 20 includes an information receiving module 201, a feed generation module 202 and a push module 203.

The information receiving module 201 is configured to receive user information sent by an SNS network client, wherein the user information may include: user identification (account and/or nickname), user's homepage link, major, age, native place, and the like.

The feed generation module 202 is configured to generate a friend feed of the user according to the user information received by the information receiving module 201, wherein the friend feed includes at least one piece of App feed information.

The server has stored the personal information of all users registered in the SNS network, the social relationships of the users, the history data of each user in the SNS network, and the like; according to the user information received by the information receiving module 201, the feed generation module 202 can search for information of all friends of this user and information of the App used by each friend, and generate a friend feed of this user according to the found information, wherein the information of the friend may include: friend identification (account and/or nickname) and friend homepage link; the information of the App used by the friend may include: identification of the App used by the friend (App ID and/or App name), details page link of the App, and the time of the friend entering the App. The App feed information includes: information of an App, information of a friend using the App and the usage time, wherein the usage time refers to: a difference value between the time when the user enters the application program store and the time when the friend enters the App.

The push module 203 is configured to push the friend feed generated by the feed generation module 202 to the SNS network client.

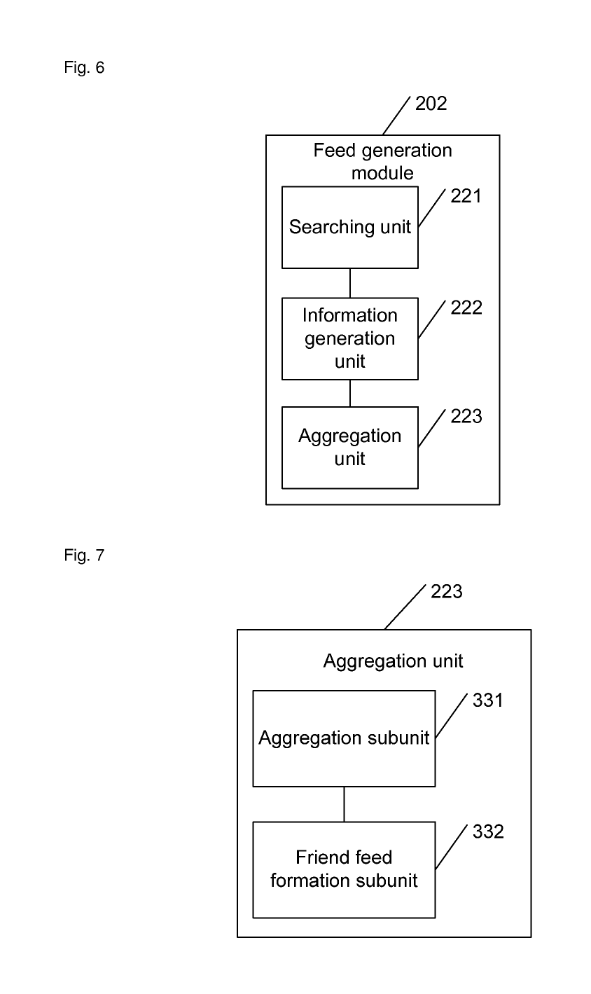

FIG. 6 shows a structure diagram of the embodiment of the feed generation module 202 shown in FIG. 5. The feed generation module 202 includes a searching unit 221, an information generation unit 222 and an aggregation unit 223.

The searching unit 221 is configured to search for friend information of at least one friend of the user and information of the App used by each friend according to the user information.

The searching unit 221 can search for friend information of at least one friend of this user stored in the server by taking the user identification contained in the user information as an index, and search for information of the App used by each friend by taking the friend identification contained in the information of each friend as an index.

The information generation unit 222 is configured to generate at least one piece of App feed information according to the friend information and the information of the App used by each friend found by the searching unit 221.

Each piece of App feed information represents the information of a friend using one App and the usage time, wherein the App feed information can be expressed as “certain friend uses certain App in certain period”, for example, “LI Ming was using App x ten minutes ago”.

The aggregation unit 223 is configured to aggregate the at least one piece of App feed information generated by the information generation unit 222 into the friend feed of the user.

The aggregation unit 223 mainly performs certain aggregation on the App feed information generated by the information generation unit 223, so that the friend feed can reflect the App use condition of friends more clearly and simply.

FIG. 7 shows a structure diagram of the embodiment of the aggregation unit 223 shown in FIG. 6. The aggregation unit 223 includes an aggregation subunit 331 and a friend feed formation subunit 332.

The aggregation subunit 331 is configured to perform aggregation on the at least one piece of App feed information generated by the information generation unit 222 according to an aggregation principle.

The aggregation principle may include: when there are at least two pieces of App feed information containing the same App information, aggregating the at least two pieces of App feed information into one piece of App feed information. For example, in the specific example mentioned in the embodiment shown in FIG. 2 to FIG. 4, user A has friends B and C; A entered App Store at 9:00, Aug. 1, 2011; B entered App 1 at 23:00, Jul. 31, 2011; C entered App 2 at 12:00, Jul. 31, 2011 and entered App 1 at 16:00, Jul. 31, 2011 respectively. According to the above information, three pieces of App feed information can be generated, including: 1. B was using App 1 ten hours ago; 2. C was using App 2 twenty-one hours ago; 3. C was using App 1 seventeen hours ago. In the above three pieces of App feed information, the first one and the third one contain the same App information, i.e., the information about App 1. According to the aggregation principle, these two pieces of App feed information can be combined into one piece of App feed information, which can be: B and C were using App 1 ten hours ago. Thus, it can be known that, during the aggregation based on this aggregation principle, the usage time in the combined App feed information selects the minimum usage time in the App feed information before combination. This principle enables the combined App feed information to reflect the latest App use condition of friends.

The aggregation principle may further include: when at least two pieces of App feed information contain the same information of the friends using the App, reserving the App feed information with the minimum usage time. According to the above example, in the three pieces of App feed information, the second one and the third one contain the same information of the friends using the App, i.e., the information of user C. According to the aggregation principle, only the App feed information with the minimum usage time is reserved, so the third App feed information is reserved. This principle enables the friend feed not only to reflect the App feed information of one friend, but also to reflect the App feed information of other friends, so that the user can learn the App use condition of friends more comprehensively.

It should be noted that the above two aggregation principles can be used separately, or in a combination; when they are used in a combination, the first aggregation principle can be adopted first and the second aggregation principle second; or, the second aggregation principle can be adopted first and the first aggregation principle second. The use of aggregation principle can depend on actual needs.

The friend feed formation subunit 332 is configured to select, according to an order from the minimum usage time to the maximum usage time, a preset number of pieces of App feed information from the App feed information obtained by the aggregation subunit 331 to form the friend feed of the user.

The preset number can be set according to actual needs, for example, according to the size of the display page of the client, the size of the area for displaying the friend feed and the number of pieces of formed App feed information. After the aggregation subunit 331 performs aggregation on the App feed information, the friend feed formation subunit 332 selects and sorts the App feed information obtained after aggregation to form a friend feed. In actual application, the friend feed formation subunit 332 can insert the App feed information obtained after aggregation into a sequence link list according to an order from the minimum usage time to the maximum usage time. When the App feed information in the sequence link list reaches a preset number, the App feed information in the sequence link list forms the friend feed, which is then pushed by the push module 203 of the serve to the client to be displayed. The display of the friend feed in the client can be referred to FIG. 3. It should be understood that, if the number of pieces of App feed information obtained after the aggregation is less than the preset number, after all the App feed information obtained after the aggregation enter the sequence linked list, the App feed information in the sequence link list forms the friend feed. The purpose of selecting App feed information according to an order from the minimum usage time to the maximum usage time is to enable the friend feed to always reflect the latest App use condition of friends.

The embodiment of the disclosure prompts the friend feed to the user when the user enters the application program store through the SNS network, wherein the friend feed reflects the App use condition of several friends of the user intensively, thereby improving the stickiness and activeness of the user and taking full advantage of SNS.

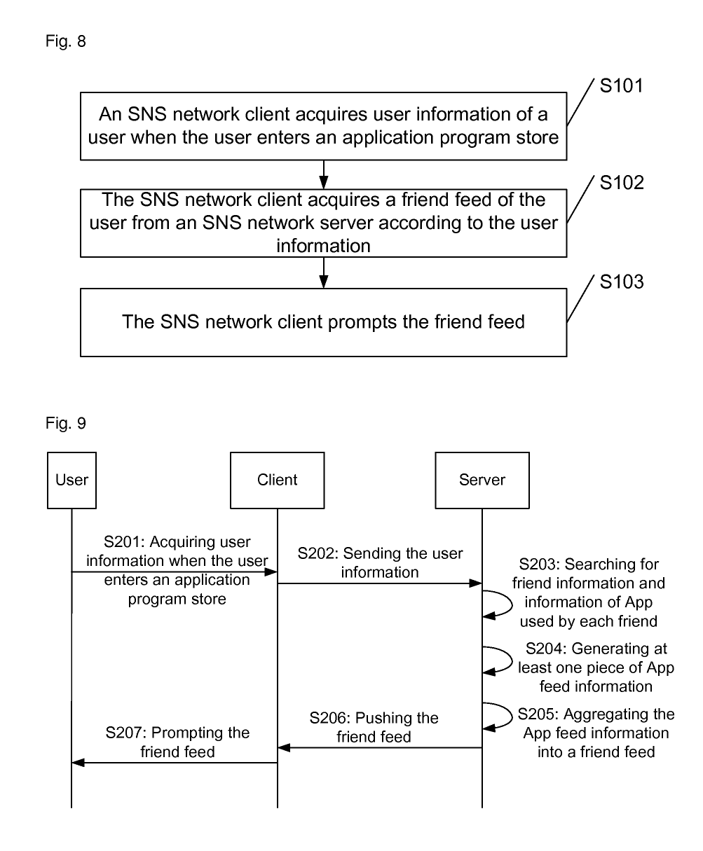

Corresponding to the system for prompting a friend feed in an SNS network provided by the embodiment of the disclosure in FIG. 1, any one client provided in FIG. 2 to FIG. 4 and any one server provided in FIG. 5 to FIG. 7, a method for prompting a friend feed in an SNS network provided by the embodiment of the disclosure is described below in detail in conjunction with FIG. 8 to FIG. 10; the above client and server provided by the embodiment of the disclosure can be applied to the following method provided by the embodiment of the disclosure for prompting a friend feed in an SNS network.

FIG. 8 shows a flowchart of one embodiment of the method for prompting a friend feed in an SNS network provided by the embodiment of the disclosure. The method includes the following steps:

Step 101: An SNS network client acquires user information of a user when the user enters an application program store.

Step 102: The SNS network client acquires a friend feed of the user from an SNS network server according to the user information, wherein the friend feed includes at least one piece of App feed information.

The App feed information may include: information of an App, information of a friend using the App and the usage time. The information of the friend includes: friend identification, friend homepage link, major, age, native place, and the like. The information of the App includes: App identification (App ID and/or App name) and details page link of the App. The usage time is the difference value between the time when the user enters the App Store and the time when the friend enters the App.

Step 103: The SNS network client prompts the friend feed.

In Step 103, the SNS network client can display the friend feed to the user, so that the user can learn the App use condition of friends intuitively. The display of the friend feed can be referred to FIG. 3. In Step 103, the SNS network client can display the friend feed at the side of App recommendation in the SNS network, so that the SNS network can attract the user to use the recommended App or other Apps in the App store according to the friend feed, thereby improving the stickiness and activeness of the user and taking full advantage of the SNS. It should be understood that in Step 103 the friend feed can be prompted through other manners such as voice and multimedia message. The analysis in these manners is similar to the above, thus giving no further description.

FIG. 9 shows a flowchart of another embodiment of the method for prompting a friend feed in an SNS network provided by the embodiment of the disclosure. The method includes the following steps:

Step 201: An SNS network client acquires user information of a user when the user enters an application program store.

Step 202: The SNS network client sends the user information to an SNS network server.

Step 203: The SNS network server searches for friend information of at least one friend of the user and information of the App used by each friend, according to the user information.

In Step 203, the SNS network server can search for friend information of at least one friend of this user stored in the server by taking the user identification contained in the user information as an index, and search for information of the App used by each friend by taking the friend identification contained in the information of each friend as an index.

Step 204: The SNS network server generates at least one piece of App feed information according to the found friend information and information of the App used by each friend.

Each piece of App feed information represents the information of a friend using one App and the usage time, wherein the App feed information can be expressed as “certain friend uses certain App in certain period”, for example, “LI Ming was using App x ten minutes ago”.

Step 205: The SNS network server aggregates the App feed information into the friend feed of the user.

In Step 205, the SNS network server mainly performs certain aggregation on the generated App feed information, so that the friend feed can reflect the App use condition of friends more clearly and simply.

Step 206: The SNS network server pushes the friend feed to the SNS network client.

Step 207: The SNS network client prompts the friend feed.

Step 207 in this embodiment can be referred to Step 103 in the embodiment shown in FIG. 8, thus giving no further description here.

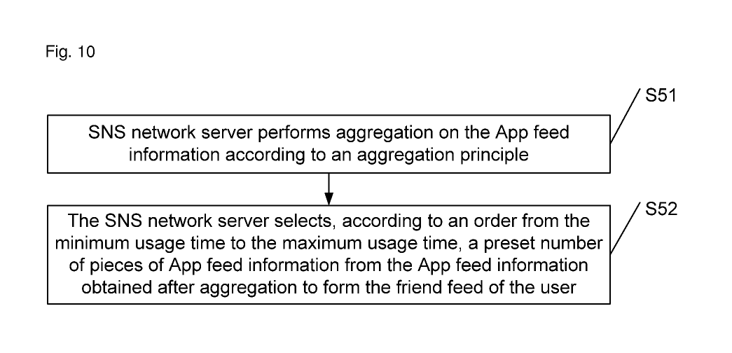

FIG. 10 shows a specific flowchart of Step 205 shown in FIG. 9. The Step 205 includes the following steps:

Step 51: The SNS network server performs aggregation on the App feed information, according to an aggregation principle.

The aggregation principle may include: when there are at least two pieces of App feed information containing the same App information, aggregating the at least two pieces of App feed information into one piece of App feed information. For example, in the specific example mentioned in the embodiment shown in FIG. 2 to FIG. 4, user A has friends B and C; A entered App Store at 9:00, Aug. 1, 2011; B entered App 1 at 23:00, Jul. 31, 2011; C entered App 2 at 12:00, Jul. 31, 2011 and entered App 1 at 16:00, Jul. 31, 2011 respectively. According to the above information, three pieces of App feed information can be generated, including: 1. B was using App 1 ten hours ago; 2. C was using App 2 twenty-one hours ago; 3. C was using App 1 seventeen hours ago. In the above three pieces of App feed information, the first one and the third one contain the same App information, i.e., the information about App 1. According to the aggregation principle, these two pieces of App feed information can be combined into one piece of App feed information, which can be: B and C were using App 1 ten hours ago. Thus, it can be known that, during the aggregation based on this aggregation principle, the usage time in the combined App feed information selects the minimum usage time in the App feed information before combination. This principle enables the combined App feed information to reflect the latest App use condition of friends.

The aggregation principle may further include: when at least two pieces of App feed information contain the same information of the friends using the App, reserving the App feed information with the minimum usage time. According to the above example, in the three pieces of App feed information, the second one and the third one contain the same information of the friends using the App, i.e., the information of user C. According to the aggregation principle, only the App feed information with the minimum usage time is reserved, so the third App feed information is reserved. This principle enables the friend feed not only to reflect the App feed information of one friend, but also to reflect the App feed information of other friends, so that the user can learn the App use condition of friends more comprehensively.

It should be noted that the above two aggregation principles can be used separately, or in a combination. When they are used in a combination, the first aggregation principle can be adopted first and the second aggregation principle second; or, the second aggregation principle can be adopted first and the first aggregation principle second. The use of aggregation principle can depend on actual needs.

Step 52: The SNS network server selects, according to an order from the minimum usage time to the maximum usage time, a preset number of pieces of App feed information from the App feed information obtained after aggregation to form the friend feed of the user.

The preset number can be set according to actual needs, for example, according to the size of the display page of the client, the size of the area for displaying the friend feed and the number of pieces of formed App feed information. After Step 51 of performing aggregation on the App feed information, in Step 52, the SNS network server selects and sorts the App feed information obtained after aggregation to form a friend feed. In actual application, the App feed information obtained after aggregation can be inserted into a sequence link list according to an order from the minimum usage time to the maximum usage time. When the App feed information in the sequence link list reaches a preset number, the App feed information in the sequence link list forms the friend feed, which is then pushed by the SNS network server to the SNS network client to be displayed. It should be understood that, if the number of pieces of App feed information obtained after the aggregation is less than the preset number, after all the App feed information obtained after the aggregation enter the sequence linked list, the App feed information in the sequence link list forms the friend feed. The purpose of selecting App feed information according to an order from the minimum usage time to the maximum usage time is to enable the friend feed to reflect the latest App use condition of friends.

Through the embodiment of the disclosure, when a user enters an application program store, the SNS network client acquires a friend feed of the user and prompts the friend feed to the user. Since the friend feed is generated and pushed in time, the user can learn the latest feed of friends. Thus, the stickiness and activeness of the user is improved and the function of the SNS is fully played, Moreover, the friend feed includes at least one piece of App feed information, that is to say, the friend feed reflects the App use condition of several friends, thereby avoiding the trouble caused by separate prompt and improving the user experience.

Those skilled in the art should understand that all or part process in the above method embodiment can be implemented by instructing related hardware through a computer program. The computer program can be stored in a computer readable storage medium, and the execution of the computer program may include the processes in the embodiment of the above methods. The computer readable storage medium can be a disk, a compact disk, a Read-Only Memory (ROM) or Random Access Memory (RAM), and the like.

The above are the preferred embodiments of the disclosure only and are not intended to limit the scope of the disclosure. Those skilled in the art should understand that all or part processes for realizing the above embodiments and equivalent changes made according to the claims of the disclosure are deemed to be included in the scope of the disclosure.

1. A method for prompting a friend feed in a Social Network Service (SNS) network, comprising:
acquiring user information of a user by an SNS network client, when the user enters an application program store;
acquiring, by the SNS network client, a friend feed of the user from an SNS network server according to the user information, wherein the friend feed comprises at least one piece of Application Program (App) feed information; and
prompting the friend feed by the SNS network client.

2. The method according to claim 1, wherein the acquiring, by the SNS network client, the friend feed of the user from the SNS network server according to the user information comprises:
sending, by the SNS network client, the user information to the SNS network server;
searching, by the SNS network server, for friend information of at least one friend of the user and App information used by each friend according to the user information, generating at least one piece of App feed information, and aggregating the App feed information into the friend feed of the user; and
pushing, by the SNS network server, the friend feed to the SNS network client.

3. The method according to claim 2, wherein the user information comprises user identification and user homepage link, and the friend information comprises friend identification and friend's homepage link;
the App information used by the friend comprises: identification of the App used by the friend and details page link of the App, and a time of the friend entering the App;
the App feed information comprises: App information, information of a friend using the App and a usage time,
wherein the usage time is a difference value between a time when the user enters the application program store and the time when the friend enters the App.

4. The method according to claim 2, wherein the aggregating the App feed information into the friend feed of the user comprises:
performing aggregation on the App feed information by the SNS network server, according to an aggregation principle;
selecting, by SNS network server, a preset number of pieces of App feed information from the App feed information obtained after aggregation according to an order from a minimum usage time to a maximum usage time to form the friend feed of the user,.

5. The method according to claim 4, wherein the aggregation principle comprises:
when there are at least two pieces of App feed information containing a same App information, aggregating the at least two pieces of App feed information into one piece of App feed information; and/or
when at least two pieces of App feed information contain a same information of the friends using the App, reserving the App feed information with a minimum usage time.

6. A client, which is applied in a Social Network Service (SNS) network, comprising:
an information acquisition module configured to acquire user information of a user when the user enters an application program store;
a feed acquisition module configured to acquire a friend feed of the user from an SNS network server according to the user information acquired by the information acquisition module, wherein the friend feed comprises at least one piece of Application Program (App) feed information; and
a prompt module configured to prompt the friend feed acquired by the feed acquisition module.

7. The client according to claim 6, wherein the feed acquisition module comprises:
a sending unit configured to send the user information acquired by the information acquisition module to the SNS network server; and
a receiving unit configured to receive the friend feed of the user pushed by the SNS network server.

8. The client according to claim 6, wherein the user information comprises user identification and a homepage link of the user;
the App feed information comprises information of an App, information of a friend using the App and a usage time, wherein
the information of the friend comprises friend identification and a homepage link of the friend; the App information comprises identification of the App and details page link of the App; and the usage time is a difference value between the time when the user enters the application program store and the time when the friend enters the App.

9. A server, which is applied in a Social Network Service (SNS) network, comprising:
an information receiving module configured to receive user information sent by an SNS network client;
a feed generation module configured to generate a friend feed of the user according to the user information received by the information receiving module, wherein the friend feed comprises at least one piece of Application Program (App) feed information; and
a push module configured to push the friend feed generated by the feed generation module to the SNS network client.

10. The serve according to claim 9, wherein the feed generation module comprises:
a searching unit configured to s friend information of at least one friend of the user and App information used by each friend according to the user information;
an information generation unit configured to generate at least one piece of App feed information according to the friend information and the App information used by each friend found by the searching unit;
an aggregation unit configured to aggregate the at least one piece of App feed information generated by the information generation unit into the friend feed of the user;
wherein the user information comprises user identification and user's homepage link; the friend information comprises friend identification and friend's homepage link; the App information used by the friend comprises: identification of the App used by the friend and details page link of the App, and a time of the friend entering the App;
the App feed information comprises: App information, information of a friend using the App and a usage time, wherein the usage time is a difference value between the time when the user enters the application program store and the time when the friend enters the App.

11. The server according to claim 10, wherein the aggregation unit comprises:
an aggregation subunit configured to perform aggregation on the at least one piece of App feed information generated by the information generation unit according to an aggregation principle; and
a friend feed formation subunit configured to select, according to an order from a minimum usage time to a maximum usage time, a preset number of pieces of App feed information from the App feed information obtained by the aggregation subunit to form the friend feed of the user;
the aggregation principle comprises:
when there are at least two pieces of App feed information containing a same App information, aggregating the at least two pieces of App feed information into one piece of App feed information; and/or
when at least two pieces of App feed information contain a same information of the friends using the App, reserving the App feed information with a minimum usage time.

12. A system for prompting a friend feed in a Social Network Service (SNS) network, comprising: a server and a client, wherein
the client is configured to acquire user information of a user when the user enters an application program store, to acquire a friend feed of the user from the server according to the user information, and to prompt the friend feed, wherein the friend feed comprises at least one piece of Application Program (App) feed information; and
the server is configured to receive the user information from the client, to generate the friend feed of the user according to the user information, and to push the friend feed to the client.

13. The method according to claim 3, wherein the aggregating the App feed information into the friend feed of the user comprises:
performing aggregation on the App feed information by the SNS network server, according to an aggregation principle;
selecting, by SNS network server, a preset number of pieces of App feed information from the App feed information obtained after aggregation according to an order from a minimum usage time to a maximum usage time to form the friend feed of the user,.

14. The method according to claim 13, wherein the aggregation principle comprises:
when there are at least two pieces of App feed information containing a same App information, aggregating the at least two pieces of App feed information into one piece of App feed information; and/or
when at least two pieces of App feed information contain a same information of the friends using the App, reserving the App feed information with a minimum usage time.

15. The client according to claim 7, wherein the user information comprises user identification and a homepage link of the user;
the App feed information comprises information of an App, information of a friend using the App and a usage time, wherein
the information of the friend comprises friend identification and a homepage link of the friend; the App information comprises identification of the App and details page link of the App; and the usage time is a difference value between the time when the user enters the application program store and the time when the friend enters the App.
